(19) United States
(12) Patent Application Publication
(10) Pub. No.: US 2020/0371724 A1
(43) Pub. Date: Nov. 26, 2020

(54) ELECTRONIC DEVICE AND NON-TRANSITORY COMPUTER-READABLE RECORDING MEDIUM STORING DISPLAY CONTENT CONTROL PROGRAM

(71) Applicant: KYOCERA Document Solutions, Inc., Osaka-Shi (JP)

(72) Inventor: Takashi MURAKAMI, Osaka-shi (JP)

(21) Appl. No.: 16/878,830

(22) Filed: May 20, 2020

(30) Foreign Application Priority Data
May 21, 2019 (JP) 2019-095165

(51) Int. Cl. G06F 3/12; G06F 3/14

(52) U.S. Cl. CPC G06F 3/1204; G06F 3/1236; G06F 3/1462

(57) ABSTRACT

An image forming apparatus for transmitting a changed portion of the data, among display content of its own display unit, to a computer while in a remote connection determines an interval for periodically switching the display content of the display unit, such that the interval while in a remote connection to a computer is longer than the interval while not in a remote connection.

### INCORPORATION BY REFERENCE

This application is based upon, and claims the benefit of priority from, corresponding Japanese Patent Application No. 2019-095165 filed in the Japan Patent Office on May 21, 2019, the entire contents of which are incorporated herein by reference.

### BACKGROUND

### Field of the Invention

The present disclosure relates to an electronic device that has a remote connection to an external device, and a non-transitory computer-readable recording medium storing a display content control program.

### Description of Related Art

A conventional electronic device, such as an image forming apparatus that has a remote connection to an external device and displays the display content of its own display unit to the display unit of the external device, is known.

FIG. 10A shows a conventional image forming apparatus when periodically switching between display A and display B on its own display unit at five second intervals. At time T1a, the image forming apparatus begins the display A on its own display unit and transmits the data for the display to an external device. Five seconds after time T1a, at time T2a, the image forming apparatus begins the display B on its own display unit and transmits the data for the display B to the external device. Five seconds after time T2a, at time T3a, the image forming apparatus begins display A on its own display unit and again transmits the data for the display A to the external device. In an ideal situation, what follows is shown in FIG. 10B. At time T1b, the external device receives the data for the display A and begins the display A on its own display unit based on the received data. Five seconds after time T1b, at time T2b, the external device receives the data for the display B and begins the display B on its own display unit based on the received data. Five seconds after time T2b, at time T3b, the external device again receives the data for the display A and begins the display A on its own display unit based on the received data. The external device periodically switches between the display A and the display B at five second intervals on its own display unit. However, the actual arrival time of data from the image forming apparatus to the external device will vary depending on the communication status with a network. Because of this, as shown in the example in FIG. 10C, at time T1b, the external device receives the data for the display A and begins the display A on its own display unit based on the received data. When the arrival time of the data from the image forming apparatus is delayed by 4.9 seconds from the ideal, at time T2b′, 9.9 seconds after time T1b, the external device receives the data for display B and begins the display B on its own display unit based on the received data. At time T3b, 0.1 seconds after time T2b′, the external device again receives the data for the display A and begins the display A on its own display unit based on the data. In the case shown in FIG. 10C, the display B is on the display unit of the external device for the time range from T2b′ to T3b, which is too short a display time to ensure that the user of the external device can understand the information from the display B.

### SUMMARY

In the present disclosure, an electronic device transmits data of at least a portion, among display content of its own display unit, that includes a part of the display content where a change occurs, to an external device while in a remote connection to the electronic device, the electronic device including a display content controller that controls the display content of the display unit, in which the display content controller determines an interval for periodically switching at least a part of the display content of the display unit, such that the interval while in a remote connection to the external device is longer than the interval while not in a remote connection to the external device.

In the present disclosure, a non-transitory computer-readable recording medium stores a display content control program. The display content control program is executed by an electronic device, for transmitting data of at least a portion, among display content of its own display unit, that includes a part of the display content where a change occurs, to an external device while in a remote connection to the electronic device, in which the program causes the electronic device to implement a display content controller that controls the display content of the display unit, and the display content controller determines an interval for periodically switching at least a portion of the display content of the display unit, such that the interval while in a remote connection to the external device is longer than the interval while not in a remote connection.

### BRIEF DESCRIPTION OF THE DRAWINGS

FIG. 1 is a block diagram of a system according to an embodiment of the disclosure;

FIG. 2 is a block diagram of an image forming apparatus shown in FIG. 1 in the case of a multifunction peripheral (MFP);

FIG. 3 is a plan view of the operation panel shown in FIG. 2;

FIG. 4A is a diagram showing an example of a screen displayed on a liquid crystal display (LCD) shown in FIG. 3;

FIG. 4B is a diagram showing an example of a screen different from the example shown in FIG. 4A;

FIG. 5 is a diagram showing an example of a switching interval information shown in FIG. 2;

FIG. 6 is a block diagram of the computer shown in FIG. 1;

FIG. 7 is a flowchart of the operation of the image forming apparatus shown in FIG. 2 during execution of a remote connection to a computer;

FIG. 8 is a flowchart of the operation of the image forming apparatus shown in FIG. 2 when the display content of a status area of the screen displayed on the LCD is periodically switched;

FIG. 9A is a diagram showing a state in which the display of the display unit of the image forming apparatus shown in FIG. 2 is periodically switched;

FIG. 9B is a diagram showing a state in which a display equivalent to the display of the display unit of the image forming apparatus is periodically switched on the display unit of the computer shown in FIG. 6;

FIG. 9C is a diagram showing a state in which a display equivalent to the display on the display unit of the image forming apparatus is irregularly switched on the display unit of the computer shown in FIG. 6;

FIG. 10A is a diagram showing a state in which the display on the display unit of a conventional image forming apparatus is periodically switched;

FIG. 10B is a diagram showing a state in which a display equivalent to the display on the display unit of the conventional image forming apparatus is periodically switched on a display unit of an external device; and

FIG. 10C is a diagram showing a state in which a display equivalent to the display on the display unit of the conventional image forming apparatus is switched irregularly on a display unit of an external device.

### DETAILED DESCRIPTION

The following describes an embodiment of the disclosure with reference to the drawings.

First, a description will be given of a system according to an embodiment of the disclosure

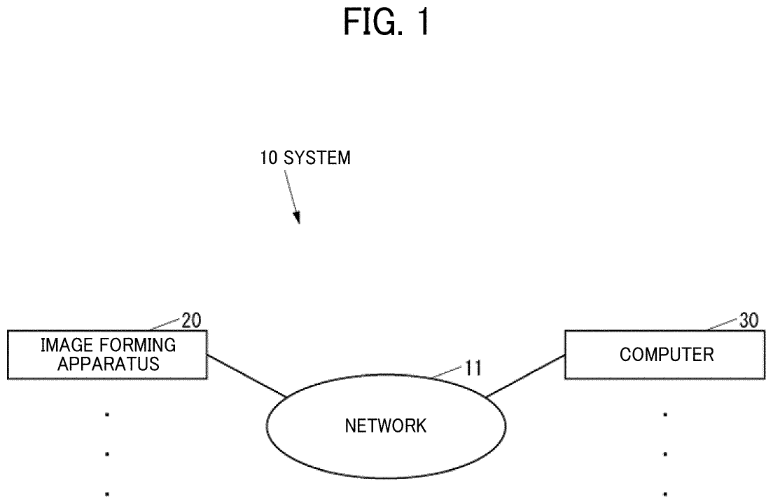

FIG. 1 shows a block diagram of a system 10 according to the present embodiment

As shown in FIG. 1, the system 10 includes an image forming apparatus 20 as an electronic device. Besides image forming apparatus 20, the system 10 may include at least one image forming apparatus similar to the image forming apparatus 20. The image forming apparatus in the system 10 may be, for example, a multifunction peripheral (MFP), a dedicated printer, a dedicated copy machine, a dedicated fax machine, a dedicated scanner, or the like. The image forming apparatus in the system 10 is used by a user who is a recipient of the image forming apparatus in the system 10 (hereinafter referred to as “a user to be provided”).

The system 10 includes a computer 30 as an external device that has a remote connection to the image forming apparatus in the system 10. Besides the computer 30, the system 10 may include at least one computer similar to the computer 30. The computer in the system 10 is, for example, a personal computer (PC). The computer in the system 10 is used by a service provider for the image forming apparatus in the system 10, such as a call center or a help desk worker (hereinafter referred to as “provider side user”).

The image forming apparatus in the system 10 and the computer in the system 10 can have a remote connection via a network 11 such as the Internet.

If the image forming apparatus in the system 10 and the computer in the system 10 have a remote connection, the system 10 can perform functions such as remote guidance and remote maintenance through cooperation of the image forming apparatus and the computer.

The remote guidance function means that the screen of the display unit of an image forming apparatus in system 10 is displayed on the display unit of a computer in system 10 so the provider side user can provide support to the user to be provided by explaining operations for the image forming apparatus by telephone. The provider side user can use the remote guidance function to check the screen on the display unit of the image forming apparatus in the system 10. Therefore, when the provider side user uses the remote guidance function to explain operations for the image forming apparatus to the user to be provided by telephone, the operations for the image forming apparatus performed by the end user can be easily understood. Moreover, when the user to be provided uses the remote guidance function to receive an explanation of operations for the image forming apparatus from the provider side user over the telephone, the instructions of the provider side user can be easily understood.

The remote maintenance function enables an image forming apparatus in the system 10 to receive adjustments and maintenance of the image forming apparatus through operations from an operation unit of a computer in the system 10. By using the remote maintenance function, the provider side user does not need to visit the installation location of the image forming apparatus in the system 10 and the maintenance cost of the image forming apparatus can be reduced.

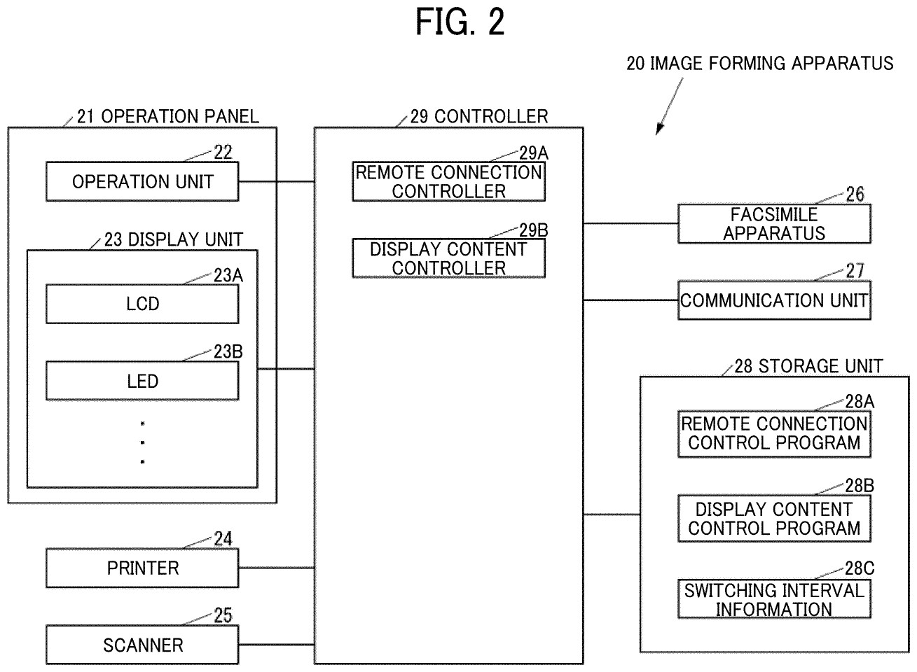

FIG. 2 is a block diagram of the image forming apparatus 20 in the case of an MFP.

The image forming apparatus 20 shown in FIG. 2 includes an operation panel 21, which accepts a variety of operations and displays a variety of information, a printer 24, which is a printing device that prints images on a recording media such as paper, a scanner 25, which is a reading device that reads images from documents, and a facsimile apparatus 26, which is a facsimile device that performs facsimile communication with external facsimile apparatuses (not shown) via a communication line such as a public telephone line. The image forming apparatus 20 also includes a communication unit 27, which is a communication device that communicates with external apparatuses either directly, meaning via a wired or wireless connection without passing through a network, or via a network such as a local area network (LAN), or the Internet. The image forming apparatus 20 also includes a storage unit 28 which is a non-volatile storage device for storing various information such as a semiconductor memory or a hard disk drive (HDD), and a controller 29 which controls the entirety of the image forming apparatus 20.

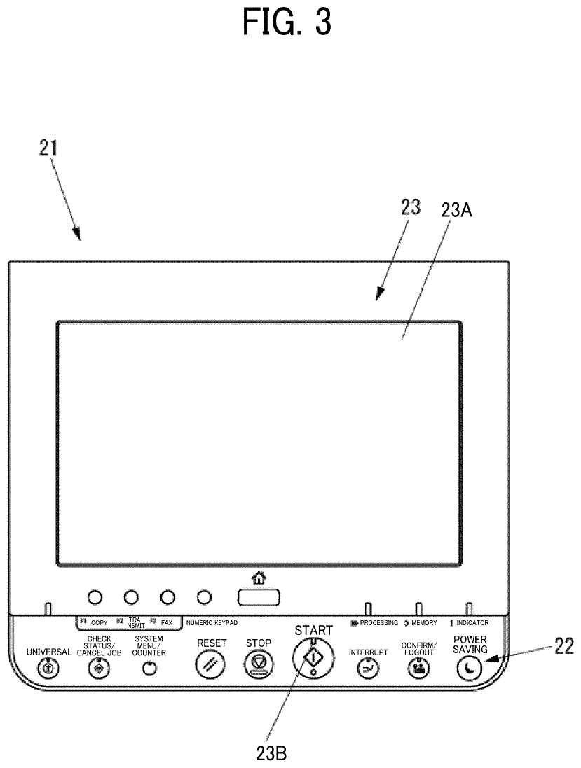

FIG. 3 is a plan view of the operation panel 21.

As shown in FIGS. 2 and 3, the operation panel 21 includes an operation unit 22 as operation devices such as buttons, which accept a variety of operations. The operation panel 21 also includes a display unit 23 which is a display device that displays various information. The display unit 23 includes a liquid crystal display (LCD) 23a and light emitting diodes (LED) 23b which include a plurality of LEDs that display a variety of information.

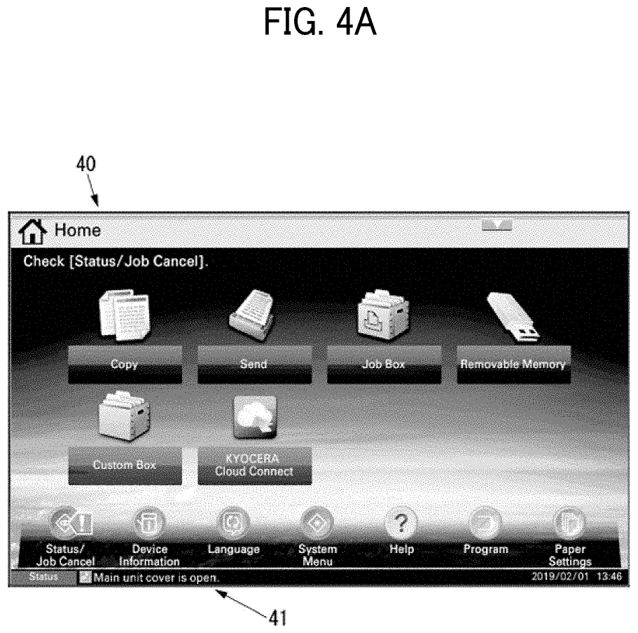

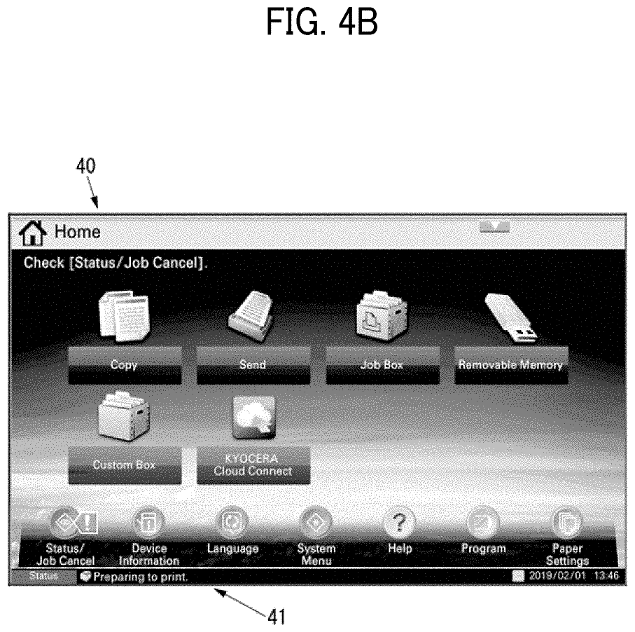

FIG. 4A is a diagram showing an example of a screen 40 displayed on the LCD 23a. FIG. 4B is a diagram showing an example of the screen 40 that is different from the example shown in FIG. 4A.

The screen 40 shown in FIGS. 4A and 4B includes a status area 41 which indicates the state of the image forming apparatus 20. In the state shown in FIG. 4A, a message “Main unit cover is open.” indicating that the cover of the main unit is open, is displayed in the status area 41. In the state shown in FIG. 4B, a message “Preparing to print.” is displayed, indicating that a print job is being prepared. The LCD 23a is periodically switched between the screen 40 shown in FIG. 4A and the screen 40 shown in FIG. 4B.

As shown in FIG. 2, the storage unit 28 can store a remote connection control program 28a for controlling a remote connection to the computer in the system 10. The remote connection control program 28a may be installed in the image forming apparatus 20, for example, at the manufacturing stage of the image forming apparatus 20. The remote connection control program 28a may also be installed from an external storage medium such as a universal serial bus memory (USB) or a secure digital (SD) card in the image forming apparatus 20, or the remote connection control program 28a may be installed in the image forming apparatus 20 from a network.

The storage unit 28 can store a display content control program 28b for controlling the display content of the display unit 23. The display content control program 28b may be installed in the image forming apparatus 20, for example, at the manufacturing stage of the image forming apparatus 20. The display content control program 28b may also be installed from an external storage medium such as a universal serial bus memory (USB) or a secure digital (SD) card in the image forming apparatus 20, or the display content control program 28b may be installed in the image forming apparatus 20 from a network.

The storage unit 28 stores switching interval information 28c which indicates time intervals for the display content to be periodically switched by the display unit 23.

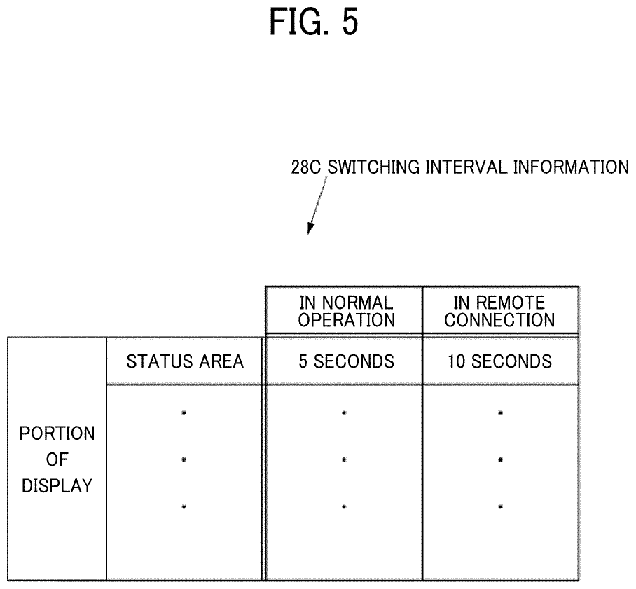

FIG. 5 is a diagram showing an example of the switching interval information 28c.

As shown in FIG. 5, the switching interval information 28c indicates, for each portion of the display of display unit 23, the interval for switching the display content while in normal operation, as in, not in a remote connection, and the interval for switching the display content while in a remote connection.

In the example shown in FIG. 5, the switching interval information 28c indicates a status area 41 as a portion of the display of the display unit 23. However, the switching interval information 28c may also include various portions of the display unit 23 other than the status area 41, as a portion of the display of the display unit 23. For example, as portions of the display unit 23, the switching interval information 28c may include various areas on the screen displayed by the LCD 23a other than the status area 41, as well as various LEDs such as any of the LEDs 23b on display unit 23.

For an identical portion of the display of the display unit 23, the interval for switching the display content while in a remote connection is longer than the interval for switching the display content while in normal operation. For example, in FIG. 5, for the status area 41, the interval for switching the display content while in a remote connection, “ten seconds”, is longer than the interval for switching the display content while in normal operation, “five seconds”.

The controller 29 shown in FIG. 2 includes, for example, a central processing unit (CPU), read only memory (ROM) for storing programs and various data, and random access memory (RAM) which is used as a work area for the CPU of the controller 29. The CPU of the controller 29 executes a program stored in the storage unit 28 or the ROM of the controller 29.

The controller 29 executes the remote connection control program 28a, which allows a remote connection controller 29a to control a remote connection to the computer in the system 10.

The controller 29 executes the display content control program 28b, which allows the display content controller 29b to control the display content of display unit 23.

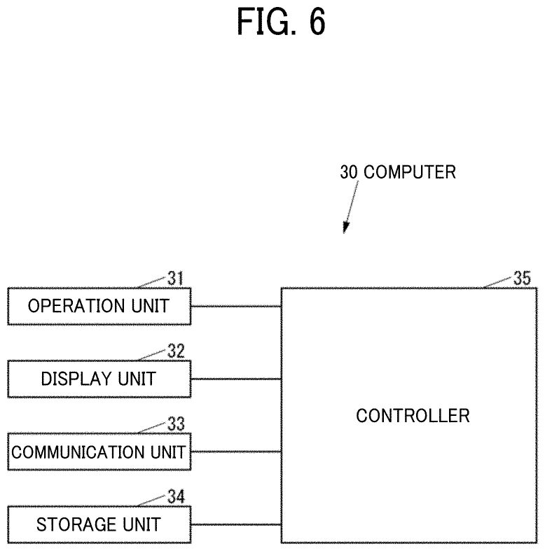

FIG. 6 is a block diagram of the computer 30.

As shown in FIG. 6, the computer 30 includes an operation unit 31, as operation devices such as a keyboard and a mouse, which accept various operations, a display unit 32 as display devices such as an LCD, which display various information, and a communication unit 33 as communication devices, which communicate with external apparatuses, either directly, meaning via a wired or wireless connection without passing through a network, or via a network such as a local area network (LAN), or the Internet. The computer 30 also includes a storage unit 34, which is a nonvolatile storage device for storing various information such as a semiconductor memory or an HDD, and a controller 35 which controls the entirety of computer 30.

The controller 35 includes, for example, a CPU, ROM which stores programs and various data, and RAM which is used as a work area of the CPU of the controller 35. The CPU of the controller 35 executes a program stored in the storage unit 34 or the ROM of the controller 35.

Next, the operation of the system 10 will be described.

First, the operation of the image forming apparatus 20 while in execution of a remote connection to the computer 30 will be described.

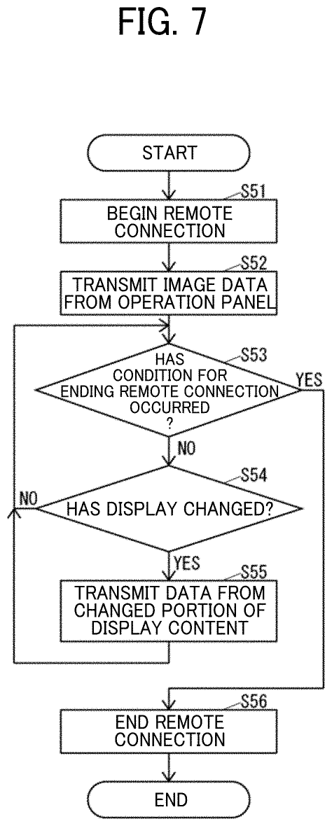

FIG. 7 is a flowchart of the operation of the image forming apparatus 20 while in execution of a remote connection to the computer 30.

When an instruction is received via the operation unit 22 to begin a remote connection to the computer 30, the controller 29 of the image forming apparatus 20 executes the operation as shown in FIG. 7.

As shown in FIG. 7, the remote connection controller 29a of the image forming apparatus 20 begins the remote connection to the computer 30 (S51).

Next, the remote connection controller 29a transmits the image data from the operation panel 21 through the communication unit 27 to the computer 30 (S52). Based on the data received via the communication unit 33, the controller 35 of the computer 30 displays the image from the operation panel 21 on the display unit 32. The data transmitted in S52 include the display content of the display unit 23, including all image data from the screen displayed on the LCD 23a and the image data from the display content of the LEDs in display unit 23.

After the process of S52, the remote connection controller 29a determines whether a specified condition for ending the remote connection to the computer 30 has occurred, such as receiving an instruction to end the remote connection via the operation unit 22 (S53)

When the remote connection controller 29a determines in S53 that the condition for ending the remote connection has not occurred, the remote connection controller 29a then determines whether the display of display unit 23 has changed (S54).

When the remote connection controller 29a determines in S54 that the display of the display unit 23 has changed, the remote connection controller 29a transmits the data from the changed portion of the display content of display unit 23 through the communication unit 27 to the computer 30 (S55). Then, the controller 35 of the computer 30 changes the image from the operation panel 21, displayed on the display unit 32 based on the data received via the communication unit 33. When there is a change in the screen displayed on the LCD 23a, the data of the image from the changed portion of the screen displayed on the LCD 23a is included in the data transmitted in S55. Further, when there is a change in the display content of the LEDs on the display unit 23, among the LEDs on the display unit 23, the data of the image indicating the display content by the LEDs whose display content has changed is included in the data transmitted in S55.

When the remote connection controller 29a determines in S54 that the display of display unit 23 has not changed, or ends the process of S55, the remote connection controller 29a executes the process of S53.

When the remote connection controller 29a determines in S53 that the condition for ending the remote connection has occurred, the remote connection controller 29a ends the remote connection to computer 30 (S56), and then ends the operation shown in FIG. 7.

Next, the operation of the image forming apparatus 20 when periodically switching the display content of the status area 41 of the screen 40 displayed on the LCD 23a will be described.

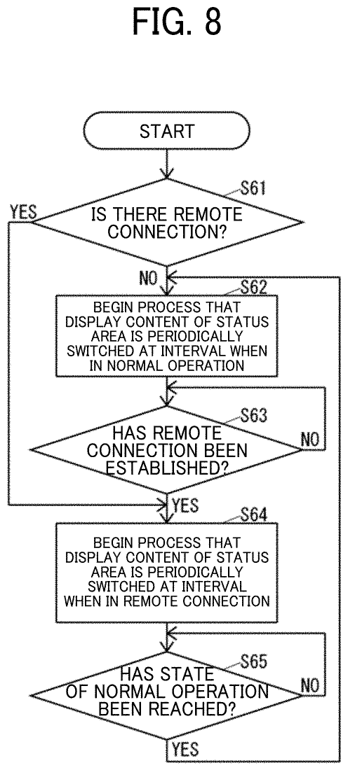

FIG. 8 is a flowchart of the operation of the image forming apparatus 20 when the display content of the status area 41 on the screen 40 displayed on the LCD 23a is periodically switched.

As shown in FIG. 8, the display content controller 29b determines whether there is a remote connection (S61).

When the display content controller 29b determines in S61 that there is no remote connection, meaning that there is normal operation, the display content controller 29b begins the process that the display content of the status area 41 is periodically switched at the interval associated with the status area 41 when in normal operation in the switching interval information 28c (S62).

Next, the display content controller 29b determines whether a remote connection has been established until the display content controller 29b is determined that a remote connection has been established (S63).

When the display content controller 29b determines in S61 that there is a remote connection, or determines in S63 that a remote connection has been established, the display content controller 29b begins the process that the display content of the status area 41 is periodically switched at the interval associated with the status area 41 while in remote connection in the switching interval information 28c (S64).

Next, the display content controller 29b determines whether normal operation has been reached until the display content controller 29b is determined that normal operation has been reached. (S65).

When the display content controller 29b is determined in S65 that normal operation has been reached, the display content controller 29b executes the process of S62.

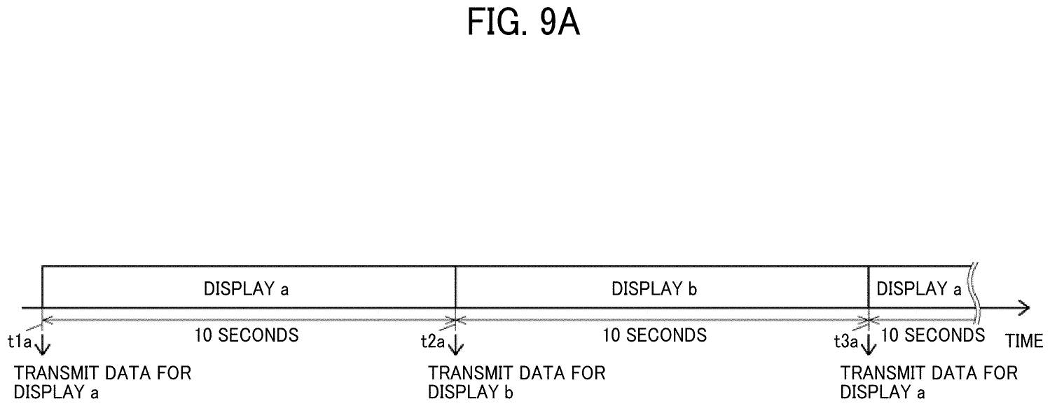

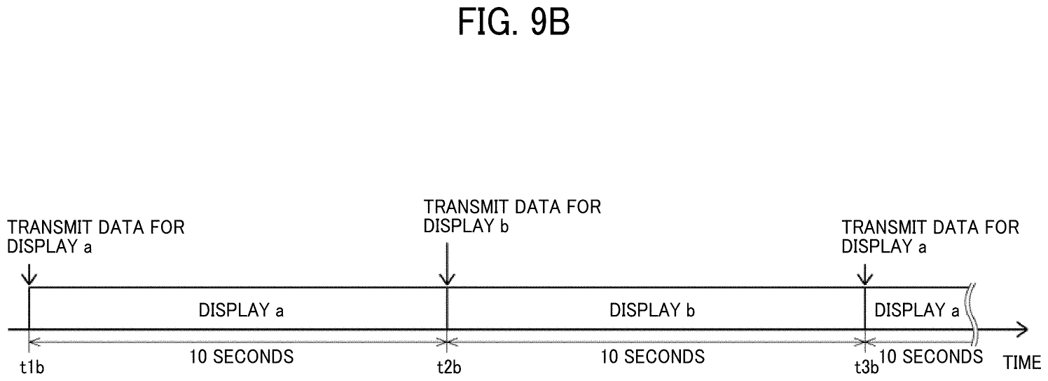

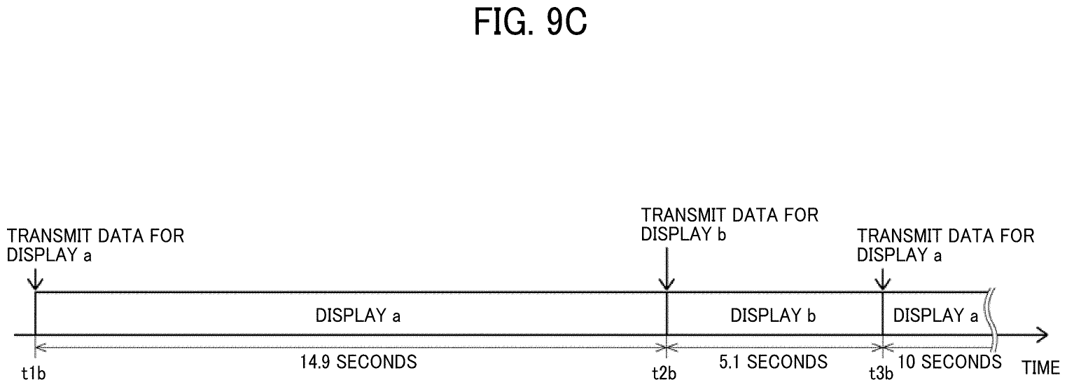

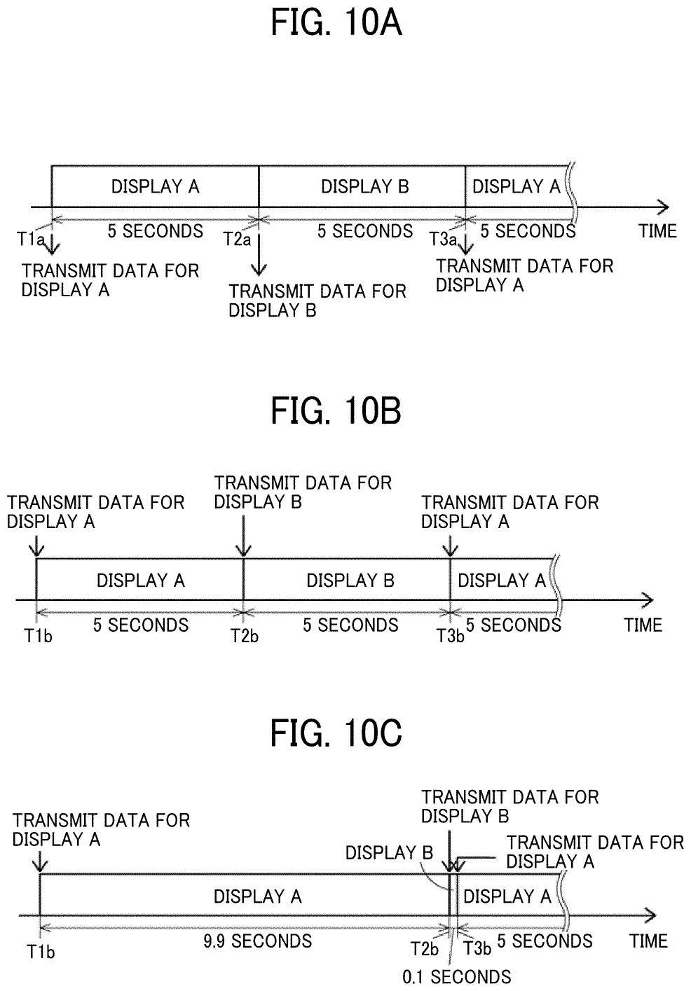

FIG. 9A is a diagram showing a state where the display of the display unit 23 of the image forming apparatus 20 is periodically switched. FIG. 9B is a diagram showing a state where a display equivalent to the display from the display unit 23 of the image forming apparatus 20 is periodically switched on the display unit 32 of the computer 30. FIG. 9C is a diagram showing a state where the display equivalent to the display on the display unit 23 of the image forming apparatus 20 is irregularly switched on the display unit 32 of the computer 30.

FIG. 9A shows a state where there is a ten second interval to switch between the status area 41 for display a and the status area 41 for display b in the display unit 23. When the display unit 23 begins the display a, the image forming apparatus 20 transmits the data for the display a to the computer 30 at time t1a. Then, ten seconds after the time t1a, at time t2a, when the display unit 23 begins the display b, the image forming apparatus 20 transmits the data for the display b to the computer 30. Then, ten seconds after the time t2a, at time t3a, when time the display unit 23 begins the display a, the image forming apparatus 20 transmits the data for the display a to computer 30. In an ideal example shown in FIG. 9B, the computer 30 receives the data for the display a at the time t1b and begins the display a, based on the data, in the display unit 32. Then, ten seconds after the time t1b, at time t2b, the computer 30 receives the data for the display b and begins the display b, based on the data, in the display unit 32. Then, ten seconds after the time t2b, at time t3b, the computer 30 receives the data for the display a and begins the display a, based on the data, in the display unit 32. In this way, the display a and the display b are switched on the display unit 32 at ten second intervals. However, the actual arrival time of data from the image forming apparatus 20 to the computer 30 varies depending on the communication status with the network 11. Therefore, in a possible example shown in FIG. 9C, the computer 30 receives the data for the display a at the time t1b and begins the display a, based on the data, in the display unit 32. Since the arrival time of the data from the image forming apparatus 20 is delayed by 4.9 seconds from the ideal, the data for the display b is received 14.9 seconds after the time t1b at the time t2b′, and the display b, based on the data, begins in the display unit 32. At the time t3b, which is 5.1 seconds after the time t2b′, the data for the display a is received, and the display a, based on the data, begins in the display unit 32. Even in the case shown in FIG. 9C, the display b has a sufficiently long display time on the display unit 32 of the computer 30 from the time t2b′ to the time t3b. Therefore, it is very likely that the information will be understood by the user of computer 30, i.e. the provider side user.

As described above, the image forming apparatus 20, in the case of periodically switching the display content of the display unit 23, lengthens the interval while in a remote connection to the computer 30, compared to the interval while not in a remote connection to the computer 30 (from S61 to S65). Even if the arrival time of data from the image forming apparatus 20 to the computer 30 during the remote connection to the computer 30 is later than ideal, it is possible to ensure the likelihood that there is sufficient display time on the display unit 32 of the computer 30 for each of the switching displays on the display unit 23 of the image forming apparatus 20. Therefore, the image forming apparatus 20 can improve the possibility that the changing display on the display unit 23 of the image forming apparatus 20 is understood by the user of the computer 30, i.e. the provider side user.

In the above description, a case has been described in which the display content of the status area 41 on the screen 40 displayed on the LCD 23a periodically switched. However, the present disclosure can be applied to a case where at least a portion of the display content of the display unit 23, other than the content of the display of the status area 41, is periodically switched. For example, the present disclosure may be applied to a case where the display content of various areas other than the status area 41 of the screen displayed on the LCD 23a are switched at regular intervals, and a case where the display content of various LEDs on the display unit 23 are periodically switched.

In the present embodiment, the image forming apparatus 20 transmits the changed portion of data for the display content from the display unit 23 to the computer 30. However, the image forming apparatus 20 may transmit any data from the display unit 23 to the computer 30 so long as it includes at least a portion of data from the display content where a change has occurred. For example, when at least a portion of the content displayed on the display unit 23 changes, the image forming apparatus 20 may transmit the entirety of the data for the content displayed on the display unit 23 to the computer 30.

The electronic device according to the present disclosure is an image forming apparatus in the present embodiment, but may be an electronic apparatus other than the image forming apparatus, such as a PC.

What is claimed is:

1. An electronic device for transmitting data of at least a portion, among display content of its own display unit, that includes a part of the display content where a change occurs, to an external device while in a remote connection to the electronic device, the electronic device comprising:
a display content controller that controls the display content of the display unit, wherein
the display content controller determines an interval for periodically switching at least a part of the display content of the display unit, such that the interval while in a remote connection to the external device is longer than the interval while not in a remote connection to the external device.

2. A non-transitory computer-readable recording medium for storing a program to be executed by an electronic device, for transmitting data of at least a portion, among display content of its own display unit, that includes a part of the display content where a change occurs, to an external device while in a remote connection to the electronic device, wherein
the program causes the electronic device to implement a display content controller that controls the display content of the display unit, and
the display content controller determines an interval for periodically switching at least a portion of the display content of the display unit, such that the interval while in a remote connection to the external device is longer than the interval while not in a remote connection.
